(19) United States
(12) Patent Application Publication
(10) Pub. No.: US 2025/0155388 A1
(43) Pub. Date: May 15, 2025

(54) PROMPT GAMMA NEUTRON ACTIVATION ANALYSIS APPARATUS

(71) Applicant: KOREA ATOMIC ENERGY RESEARCH INSTITUTE, Daejeon (KR)

(72) Inventors: Sunghwan YUN, Daejeon (KR); Dong Won LEE, Daejeon (KR); Hyung Gon JIN, Daejeon (KR); Bongki JUNG, Daejeon (KR)

(21) Appl. No.: 18/945,760

(22) Filed: Nov. 13, 2024

(30) Foreign Application Priority Data
Nov. 15, 2023 (KR) 10-2023-0158366

(51) Int. Cl. G01N 23/22; G01N 23/00; G21F 1/08

(52) U.S. Cl. CPC G01N 23/22; G01N 23/005; G21F 1/085

(57) ABSTRACT

A prompt gamma neutron activation analysis (PGNAA) apparatus for measuring prompt gamma rays emitted by irradiating a material to be analyzed with neutrons according to an exemplary embodiment of the present disclosure is a PGNAA apparatus including: a case having a predetermined thickness; a neutron shield disposed inside the case and having a predetermined thickness, with a source space in which a neutron source is disposed and a target space extending on one side of the source space for inserting the target material therein; a gamma-ray measurement passage communicating with the outside by penetrating the neutron shield and the case from the target space; and a gamma meter disposed outside adjacent to the gamma-ray measurement passage to measure prompt gamma rays emitted from the target material.

### CROSS-REFERENCE TO RELATED APPLICATION

This application claims priority to and the benefit of Korean Patent Application No. 10-2023-0158366 filed in the Korean Intellectual Property Office on Nov. 15, 2023, the entire contents of which are incorporated herein by reference.

### BACKGROUND OF THE INVENTION

### (a) Field of the Invention

The present disclosure relates to a prompt gamma neutron activation analysis apparatus. More particularly the present disclosure relates to a prompt gamma neutron activation analysis apparatus for safely and accurately measuring prompt gamma rays generated by applying a neutron source and analyzing a target material.

### (b) Description of the Related Art

A prompt gamma neutron activation analysis (PGNAA) apparatus is a non-contact, non-destructive analysis technique for use in analyzing elemental compositions of bulk raw materials. When a material is irradiated with neutrons, the neutrons interact with elements of the target material, emitting secondary, immediate gamma rays that can be measured. While other analysis techniques are surface analysis techniques, the PGNAA technique is a neutron activation analysis technique, which is advantageous in that the entire volume of the raw material, as well as the surface of the raw material, can be measured by passing through the inside of the raw material.

A conventional PGNAA analyzer is disposed directly on a conveyor belt and is structured to penetrate the cross-section of the entire raw material, so that the entire raw material stream as well as lower samples can be uniformly measured on a minute-by-minute basis. However, the conventional PGNAA analyzer have limitations in applying a neutron source having a high yield (a high neutron emission per hour) to a general industrial site for the reason that radiation shielding or the like is required due to neutron leakage, and the high-yield neutron source is applied only on a laboratory scale.

As related prior art documents, Korean Patent No. 0988574 discloses “a fuel rod scanner using a neutron generator,” Korean Patent No. 2442077 discloses “a method and an apparatus for multielement analysis based on neutron activation and use thereof,” and Japanese Patent Laid-Open Publication No. 2022-156127 discloses a “non-destructive inspection device”.

### PRIOR ART

### Patent Docoment

(Patent Document 1) Korean Patent No. 0988574
(Patent Document 2) Korean Patent No. 2442077
(Patent Document 3) Japanese Patent Laid-Open Publication No. 2022-156127

### SUMMARY OF THE INVENTION

The present disclosure attempts to provide a structure for designing a prompt gamma neutron activation analysis (PGNAA) apparatus capable of maximizing a neutron reaction rate of a target material by using beryllium (Be), minimizing a leaked neutron dose by applying a neutron shield, and measuring emitted prompt gamma rays by providing a gamma-ray measurement passage.

An exemplary embodiment of the present disclosure provides a prompt gamma neutron activation analysis (PGNAA) apparatus for measuring prompt gamma rays emitted by irradiating a material to be analyzed with neutrons, the PGNAA apparatus including: a case having a predetermined thickness; a neutron shield disposed inside the case and having a predetermined thickness, with a source space in which a neutron source is disposed and a target space extending on one side of the source space for inserting the target material therein; a gamma-ray measurement passage communicating with the outside by penetrating the neutron shield and the case from the target space; and a gamma meter disposed outside adjacent to the gamma-ray measurement passage to measure prompt gamma rays emitted from the target material.

An inner wall of the target space may be covered with a moderator made of one of metallic beryllium (Be), beryllium oxide (BeO), magnesium oxide (MgO), light water (H₂O), and heavy water (D₂O).

The moderator may have a thickness of 3.5 cm to 4.5 cm.

An outer wall of the case may be covered with a neutron absorber made of one of boron carbide (B₄C), borated steel, and cadmium (Cd).

The neutron shield may be made one of polyethylene (HDPE), titanium hydride (TiH₂), zirconium borohydride (Zr(BH₄)₄), magnesium borohydride (Mg(BH₄)₂), and yttrium dihydride (YH₂).

The neutron shield may have a thickness of 30 cm to 34 cm.

The target space may be a space having a predetermined depth and formed in a rectangular shape while being smaller than the source space.

The target space may have a depth of 15.5 cm to 16.5 cm.

The gamma-ray measurement passage may extend in a direction perpendicular to an inner wall of the target space or extend at a certain angle in a vertical direction.

The gamma-ray measurement passage may be formed to have a circular cross-section.

An inner wall of the gamma-ray measurement passage may be covered with a gamma-ray shield.

The gamma-ray shield may have a thickness of 1 cm or more.

The gamma-ray shield may be made of lead (Pb).

The PGNAA apparatus may further include: a dummy neutron shield formed inside the case, the dummy neutron shield being formed integrally with the neutron shield and having a size larger than or equal to a size of the target space.

The dummy neutron shield may be formed at a position spaced apart from the target space at a predetermined distance in a direction that is the same as a direction in which the neutron source faces the target space.

The neutron shield and the dummy neutron shield may be surrounded by a gamma-ray shield.

The gamma-ray shield may be made of lead (Pb).

The target space may communicate with a penetration portion formed for a conveyor belt on which the target material is placed to penetrate the case and the neutron shield.

The penetration portion may have a height that is equal to a height of the target space.

The PGNAA apparatus may further include: a dummy boron carbide (B₄C) neutron absorber formed in the gamma-ray measurement passage.

The PGNAA apparatus according to an exemplary embodiment of the present disclosure is capable of minimizing the leaked neutron dose even though a high-yield neutron source is used, by applying a neutron shield.

In addition, the PGNAA apparatus according to an exemplary embodiment of the present disclosure is capable of improving the gamma-ray measurement efficiency, by applying a beryllium moderator to maximize the rate at which the material to be measured reacts with neutrons.

In addition, the PGNAA apparatus according to an exemplary embodiment of the present disclosure is capable of improving the reliability of measurement results, by connecting a gamma-ray measurement passage to a space where there is a material to be analyzed, covering the gamma-ray measurement passage with a gamma-ray shield, and locating a gamma meter at an exit of the gamma-ray measurement passage to accurately measure only gamma rays that have reacted with the target material as much as possible.

In addition, the present disclosure, which proposes a concept for designing a neutron shield, can be easily applied to conventional PGNAA apparatuses.

### BRIEF DESCRIPTION OF THE DRAWINGS

FIG. 1 is a view schematically showing a PGNAA apparatus according to an exemplary embodiment of the present disclosure.

FIG. 2 is an enlarged view showing portion ‘A’ of FIG. 1.

FIG. 3 is a view showing a change in neutron dose rate depending on position in a target space P in the PGNAA apparatus according to an exemplary embodiment of the present disclosure.

FIG. 4 is a view showing a neutron dose rate distribution when a depth X of the target space P is 16 cm in the PGNAA apparatus according to an exemplary embodiment of the present disclosure.

FIG. 5 is a view showing a change in (η, γ) reaction rate depending on position in the target space P in the PGNAA apparatus according to an exemplary embodiment of the present disclosure.

FIG. 6 is a view schematically showing a PGNAA apparatus according to another exemplary embodiment of the present disclosure.

FIG. 7 is a cross-sectional view taken along line ‘B-B’ of FIG. 6.

FIG. 8 is a view showing the PGNAA apparatus of FIG. 6 as viewed from above.

FIG. 9 is a view showing a neutron dose rate distribution in the PGNAA apparatus according to another exemplary embodiment of the present disclosure shown in FIG. 6.

FIG. 10 is a view showing a neutron dose rate distribution in the PGNAA apparatus according to another exemplary embodiment of the present disclosure shown in FIG. 8.

FIG. 11 is a view showing a gamma dose rate distribution in the PGNAA apparatus according to another exemplary embodiment of the present disclosure shown in FIG. 6.

FIG. 12 is a view showing a gamma dose rate distribution in the PGNAA apparatus according to another exemplary embodiment of the present disclosure shown in FIG. 8.

FIG. 13 is a view showing a neutron dose rate distribution in the absence of any target material in the PGNAA apparatus according to another exemplary embodiment of the present disclosure shown in FIG. 6.

FIG. 14 is a view showing a neutron dose rate distribution in the absence of any target material in the PGNAA apparatus according to another exemplary embodiment of the present disclosure shown in FIG. 8.

FIG. 15 is a view showing a gamma dose rate distribution in the absence of any target material in the PGNAA apparatus according to another exemplary embodiment of the present disclosure shown in FIG. 6.

FIG. 16 is a view showing a gamma dose rate distribution in the absence of any target material in the PGNAA apparatus according to another exemplary embodiment of the present disclosure shown in FIG. 8.

FIG. 17 is a graph showing a shielding effect, which is expressed as a measured gamma signal, when a gamma-ray shield is placed in a gamma-ray measurement passage in the PGNAA apparatus according to an exemplary embodiment of the present disclosure.

FIG. 18 is a view showing a state in which a dummy neutron absorber is further provided in the gamma-ray measurement passage of the PGNAA apparatus according to an exemplary embodiment of the present disclosure.

FIG. 19 is a view showing a neutron dose rate distribution in the PGNAA apparatus according to an exemplary embodiment of the present disclosure shown in FIG. 18.

FIG. 20 is a graph showing a gamma signal measured in the PGNAA apparatus according to an exemplary embodiment of the present disclosure shown in FIG. 18.

### DETAILED DESCRIPTION OF THE EMBODIMENTS

Hereinafter, exemplary embodiments of the present disclosure will be described in detail with reference to the accompanying drawings, so that they can be easily carried out by those having ordinary knowledge in the art to which the present disclosure pertains. However, the present disclosure may be implemented in various different forms, and is not limited to the exemplary embodiments described herein. In order to clearly explain the present disclosure, parts irrelevant to the description will be omitted from the drawings, and the same reference numerals will be used for identical or similar components throughout the specification. In addition, detailed descriptions of widely known technologies will be omitted.

Throughout the specification, when a certain part is referred to as “including” a certain component, this implies the presence of other components, not precluding the presence of other components, unless explicitly stated to the contrary.

Then, a prompt gamma neutron activation analysis (PGNAA) apparatus according to an exemplary embodiment of the present disclosure will be described.

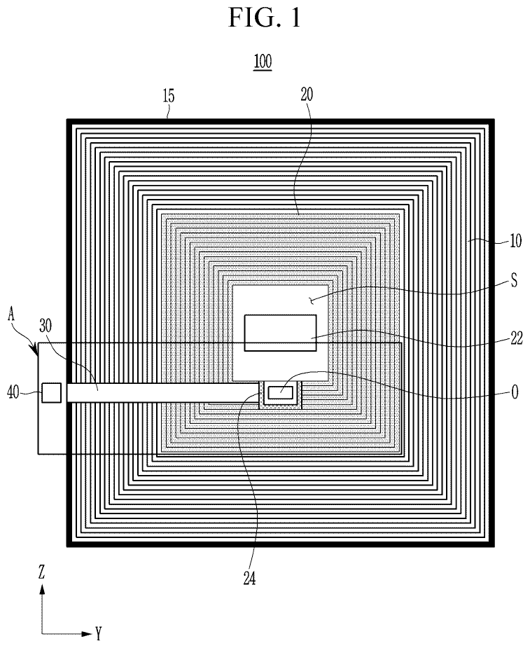

FIG. 1 is a view schematically showing a PGNAA apparatus according to an exemplary embodiment of the present disclosure.

Referring to FIG. 1, a PGNAA apparatus 100 according to an exemplary embodiment of the present disclosure is an apparatus for measuring prompt gamma rays emitted by irradiating a target material O to be analyzed with neutrons. When the target material O is irradiated with neutrons, a neutron absorption reaction ((η, γ) reaction) occurs, and it is necessary to increase the neutron absorption reaction to generate more prompt gamma rays. Most neutron absorption reactions are caused by thermal neutrons between 0.01 eV and about 0.1 eV. That is, in order to increase the efficiency in inspecting ingredients of the target material O, it is required that neutrons of about 2.5 MeV generated from a neutron source 22 be moderated into thermal neutrons in a situation where there is no neutron flux moderation as much as possible.

As shown in FIG. 1, the PGNAA apparatus 100 according to an exemplary embodiment of the present disclosure may include a case 10 having a predetermined thickness, a neutron shield 20 disposed inside the case 10 and having a predetermined thickness with a space formed therein, a gamma-ray measurement passage 30 communicating with the outside by penetrating the neutron shield 20 and the case 10 from the space inside the neutron shield 20, and a gamma meter 40 disposed outside adjacent to the gamma-ray measurement passage 30.

The case 10 may be formed in a square shape with a predetermined thickness, and the outer wall of the case 10 may be covered with a boron carbide (B₄C) neutron absorber 15 to shield neutrons generated inside the case 10. The neutron absorber 15 may be made of borated steel or cadmium (Cd).

The neutron shield 20 may be disposed inside the case 10 in the same shape as the case 10, and may have a predetermined thickness. The neutron shield 20 may be made of a polyethylene (HDPE) material, and may have a thickness of about 30 cm to about 34 cm. An empty space (a margin) for designing and adjusting the thickness of the neutron shield 20 may be provided between the neutron shield 20 and the case 10. The neutron shield may be made of one of titanium hydride (TiH₂), zirconium borohydride (Zr(BH₄)₄), magnesium borohydride (Mg(BH₄)₂), and yttrium dihydride (YH₂).

A source space S in which the neutron source 22 is disposed may be formed inside the neutron shield 20. The source space S may be formed in a central portion of the neutron shield 20, and may be formed as a rectangular space.

In addition, a target space P extending on one side of the source space S may be formed inside the neutron shield 20, with the target material O being inserted in the target space P. The target space P may be a smaller space than the source space S. The target space P may have a predetermined depth, and may be formed in a rectangular shape. In an exemplary embodiment, the target space P may be formed integrally with the source space S under the source space S.

Meanwhile, the inner wall of the target space P may be covered with a moderator 24 made of metallic beryllium (Be). One efficient way to replace high-speed neutrons of 1 MeV or more with thermal neutrons is to use (n, 2n) reaction of beryllium. The (n, 2n) reaction of beryllium is that Beryllium absorbs one high-speed neutron of about 1.4 MeV or more and emits two thermal neutrons of about 0.1 eV.

In this case, the beryllium moderator 24 may have a thickness of about 3.5 cm to about 4.5 cm. When about 4 cm of beryllium is added to the inner wall of the target space P, i.e., the neutron shield 20, an increase in (η, γ) reaction of about 10% or more can be observed, and it can be confirmed that the (η, γ) reaction increases up to two times as the amount of beryllium added increases.

The moderator 24 may be made of one of beryllium oxide (BeO), magnesium oxide (MgO), light water (H₂O), and heavy water (D₂O) as well as metallic beryllium.

The gamma-ray measurement passage 30 may be formed to communicate with the outside by penetrating the neutron shield 20 and the case 10 from the target space P.

The gamma-ray measurement passage 30 may extend in a direction perpendicular to the inner wall of the target space P. Prompt gamma rays generated by the neutron absorption reaction in the target material O need to effectively reach a gamma meter 40. At this time, if the gamma meter 40 is irradiated with excessive neutrons, its measurement performance cannot be properly exhibited. In addition, since neutron leakage may occur in a space where prompt gamma rays reach the gamma meter 40, which may increase the neutron dose rate, it is required that this influence be eliminated as much as possible. Therefore, the gamma meter 40 needs to be positioned such that prompt gamma rays generated from the target material O smoothly reach the gamma meter 40 while preventing neutrons from reaching the gamma meter 40 as much as possible.

In an exemplary embodiment of the present disclosure, the gamma meter 40 is disposed adjacent to an exit of the gamma-ray measurement passage 30 outside the case 10, and the direction in which the gamma-ray measurement passage 30 extends may be set to be a direction perpendicular to the inner wall of the target space P. In addition, the gamma-ray measurement passage 30 may also be configured to extend at a certain angle in the vertical direction with respect to the inner wall of the target space P.

The gamma meter 40 may be a NaI gamma meter 40 having a diameter of about 7.6 cm and a length of about 7.6 cm.

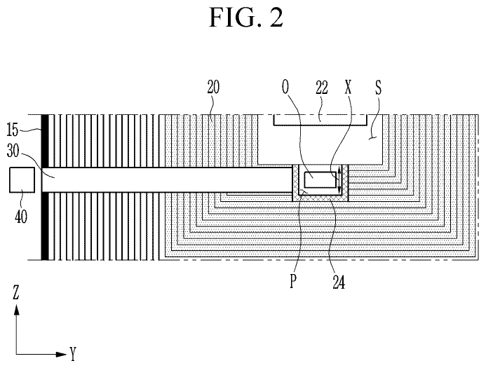

FIG. 2 is an enlarged view showing portion ‘A’ of FIG. 1.

Referring to FIG. 2, a depth X of the target space P may be defined from the position where the neutron shield 20 under the source space S begins to the position where the beryllium moderator 24 under the inner wall of the target space P begins. In an exemplary embodiment of the present disclosure, the depth X of the target space P may be from about 15.5 cm to about 16.5 cm.

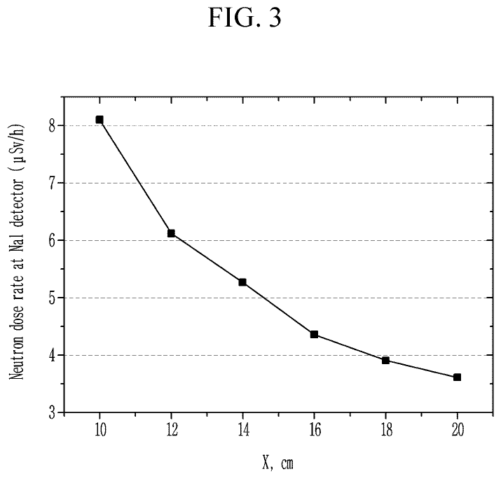

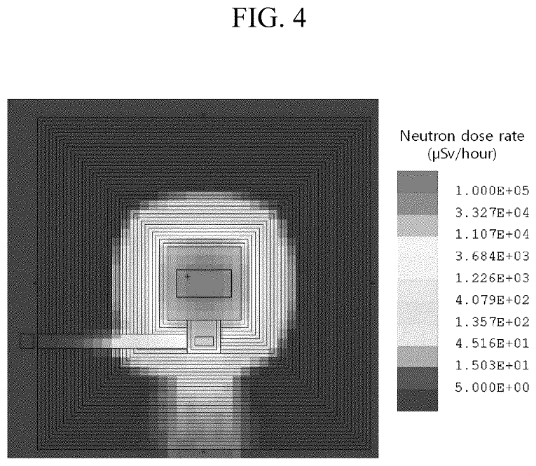

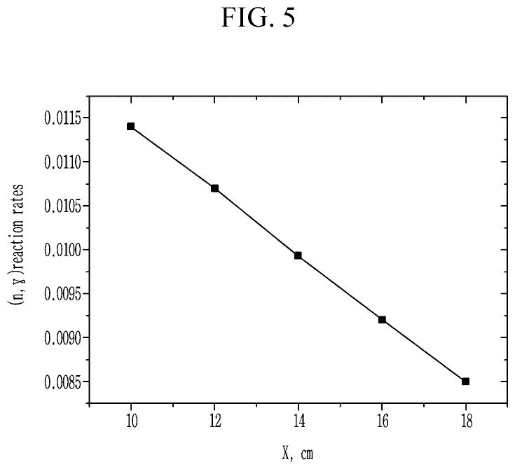

FIG. 3 is a view showing a change in neutron dose rate depending on position in the target space P in the PGNAA apparatus according to an exemplary embodiment of the present disclosure, FIG. 4 is a view showing a neutron dose rate distribution when the depth X of the target space P is 16 cm in the PGNAA apparatus according to an exemplary embodiment of the present disclosure, and FIG. 5 is a view showing a change in (η, γ) reaction rate depending on position in the target space P in the PGNAA apparatus according to an exemplary embodiment of the present disclosure.

Referring to FIG. 3, it can be confirmed that when the depth X of the target space P inside the neutron shield 20 is about 15 cm or more, the neutron dose rate at the position of the gamma meter 40 drops to 5 μSv/hour or lower, which is a target dose rate. In addition, referring to FIG. 4, it can be confirmed that the neutron dose rate around the gamma-ray measurement passage 30 is also below the reference value. However, in this case, as shown in FIG. 5, as the depth X of the target space P increases, the target material O is farther away from the neutron source 22, and the (η, γ) reaction decreases. Therefore, in order to secure the (η, γ) reaction while keeping the neutron dose rate below the target dose rate of 5 μSv/hour, the depth X of the target space P is set to about 16 cm, thereby locating the target space P at the optimal position.

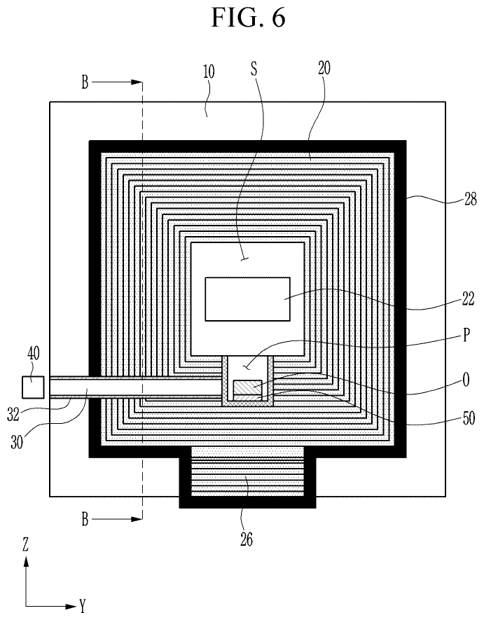

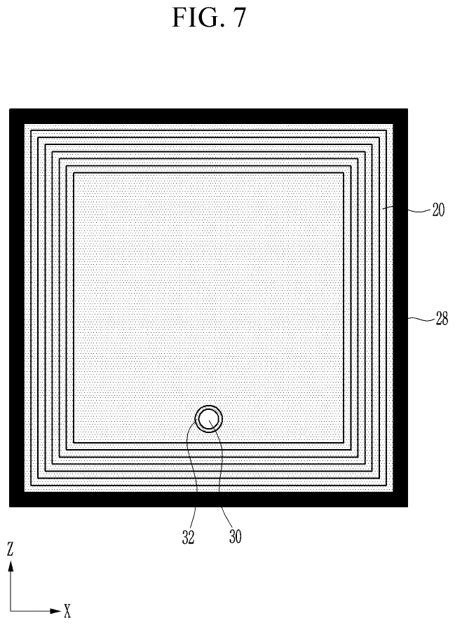

FIG. 6 is a view schematically showing a PGNAA apparatus according to another exemplary embodiment of the present disclosure, and FIG. 7 is a cross-sectional view taken along line ‘B-B’ of FIG. 6.

Referring to FIG. 6, the PGNAA apparatus according to another exemplary embodiment of the present disclosure may further include a dummy neutron shield 26 formed integrally with the neutron shield 20 inside the case 10. The dummy neutron shield 26 may be formed in a size greater than the size of the target space P. In addition, the dummy neutron shield 26 may be formed at a position spaced apart from the target space P by a predetermined distance in a direction that is the same as the direction in which the neutron source 22 faces the target space P.

The perimeter of the neutron shield 20 and the dummy neutron shield 26 may be surrounded by a gamma-ray shield 28. The gamma-ray shield 28 may be made of lead (Pb). In addition, the gamma-ray shield 28 may have a thickness of about 4 cm.

Meanwhile, the inner wall of the gamma-ray measurement passage 30 may also be covered with a gamma-ray shield 32. In this case, the gamma-ray shield 32 disposed on the inner wall of the gamma-ray measurement passage 30 may have a thickness of about 1 cm or more, and may be made of lead (Pb). In the gamma-ray measurement passage 30, gamma-rays generated through the neutron shield 20 may be transmitted as “background noise” in directions not facing the target material O. To reduce the background noise, it is effective to cover the inner wall of the gamma-ray measurement passage 30 with the gamma-ray shield 32 made of lead, which is a heavy element.

Meanwhile, as shown in FIG. 7, the gamma-ray measurement passage 30 may be formed to have a circular cross-section. The gamma-ray measurement passage 30 being formed to have a circular cross-section is shown as an example, and the shape of the cross-section of the gamma-ray measurement passage 30 is not limited to a circular shape, and the gamma-ray measurement passage 30 may be formed in various shapes.

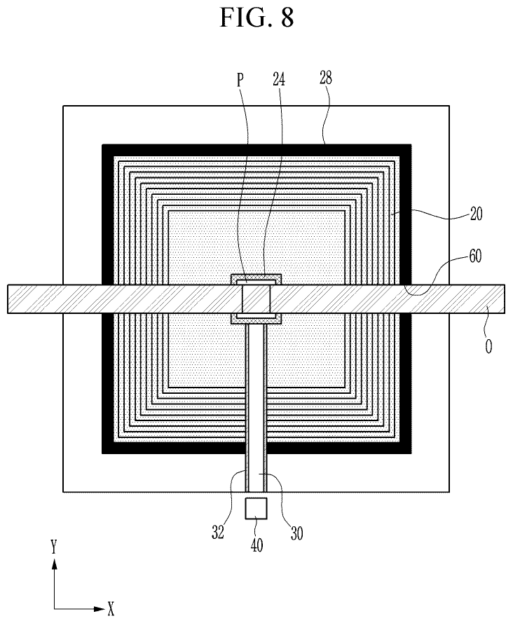

FIG. 8 is a view showing the PGNAA apparatus of FIG. 6 as viewed from above.

Referring to FIG. 8, the case 10, the neutron shield 20, and the target space P may be connected to a penetration portion 60 formed on an external side of the case 10. A conveyor belt on which the target material O is placed may be formed to extend into the case 10 and the neutron shield 20 through the penetration portion 60. That is, the target material O may be moved from the outside on one side of the case 10 to one side of the neutron shield 20, the target space P, the other side of the neutron shield 20, and the outside on the other side of the case 10 on the conveyor belt as the conveyor belt operates. The conveyor belt may be made of aluminum (Al).

Since the gamma-ray measurement passage 30 is connected to the target space P, when the target material O is positioned in the target space P while moving on the conveyor, gamma rays generated from the target material O may be measured through the gamma meter 40. To this end, the penetration portion 60 may have a height that is approximately equal to the height of the target space P.

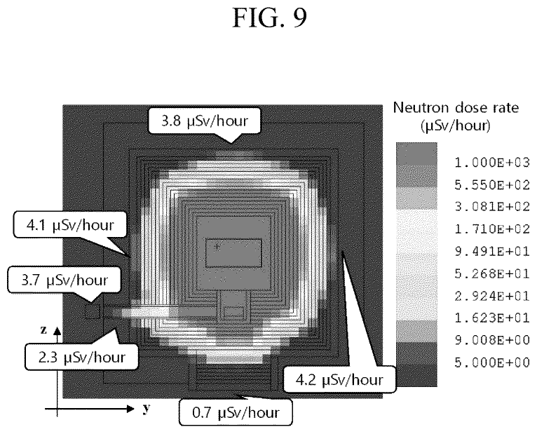

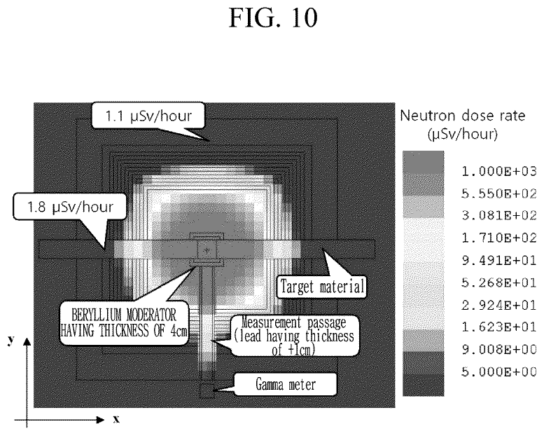

FIG. 9 is a view showing a neutron dose rate distribution in the PGNAA apparatus according to another exemplary embodiment of the present disclosure shown in FIG. 6, and FIG. 10 is a view showing a neutron dose rate distribution in the PGNAA apparatus according to another exemplary embodiment of the present disclosure shown in FIG. 8.

As shown in FIGS. 9 and 10, it can be confirmed that the positions of the gamma-ray measurement passage 30 and the target space P make it possible to prevent an occurrence of neutron leakage not only in the gamma-ray measurement passage 30 but also in the penetration portion 60, and to maintain the target neutron dose rate below 5 μSv/hour on the surface of the PGNAA apparatus.

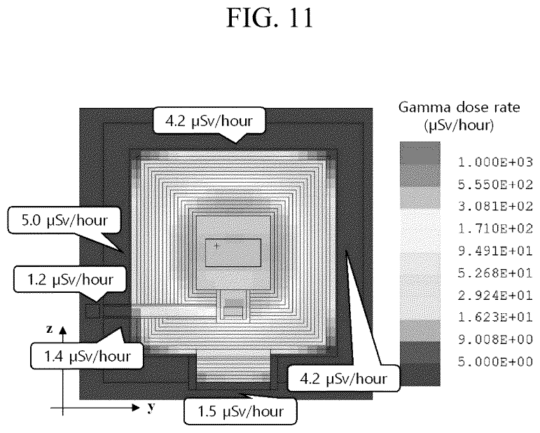

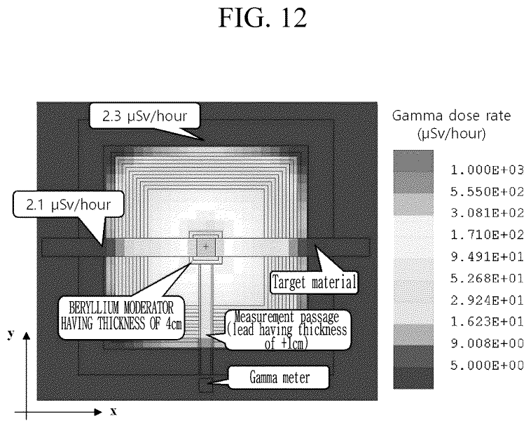

FIG. 11 is a view showing a gamma dose rate distribution in the PGNAA apparatus according to another exemplary embodiment of the present disclosure shown in FIG. 6, and FIG. 12 is a view showing a gamma dose rate distribution in the PGNAA apparatus according to another exemplary embodiment of the present disclosure shown in FIG. 8.

As shown in FIGS. 11 and 12, it can be confirmed that no additional gamma shield is required for the gamma-ray measurement passage 30, the conveyor belt, and the penetration portion (60) by simply covering the neutron shield 20 of the PGNAA apparatus with the gamma-ray shield 28 at a certain thickness.

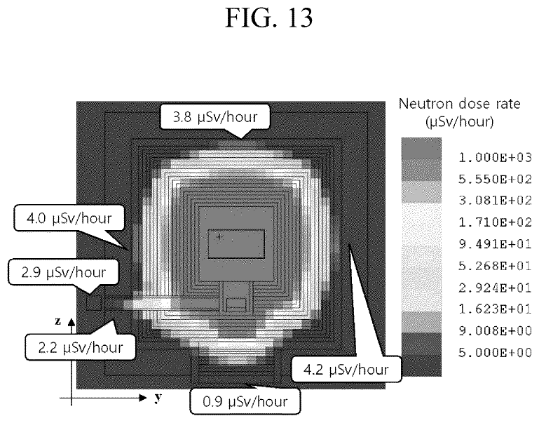

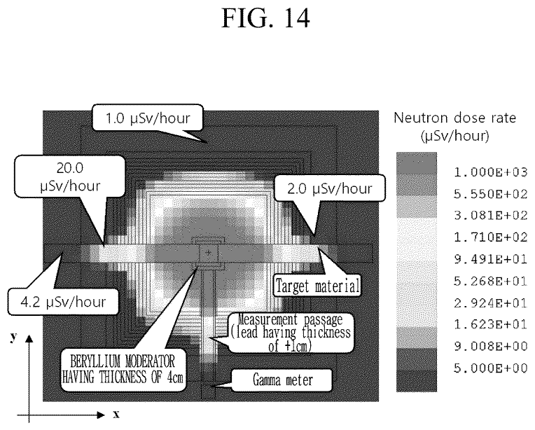

FIG. 13 is a view showing a neutron dose rate distribution in the absence of any target material in the PGNAA apparatus according to another exemplary embodiment of the present disclosure shown in FIG. 6, and FIG. 14 is a view showing a neutron dose rate distribution in the absence of any target material in the PGNAA apparatus according to another exemplary embodiment of the present disclosure shown in FIG. 8.

Referring to FIGS. 13 and 14, when no target material O is inserted into the PGNAA apparatus, neutron and gamma-ray leakage may occur in the target space P. Concerning neutron dose, it is confirmed that there is no big problem in a y-z direction shown in FIG. 13, but leakage occurs in the space where there is no target material O in an x-y direction shown in FIG. 14. However, it can be seen that the neutron dose rate drops to about 4.2 μSv/hour or lower in a space apart from the PGNAA apparatus by about 22 cm, and the neutron dose rate satisfies 2.0 μSv/hour, which is a reference value, at a distance of about 5 cm from the conveyor belt even near the surface of the PGNAA apparatus.

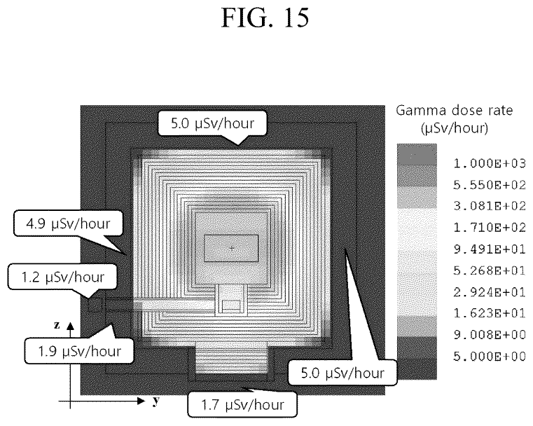

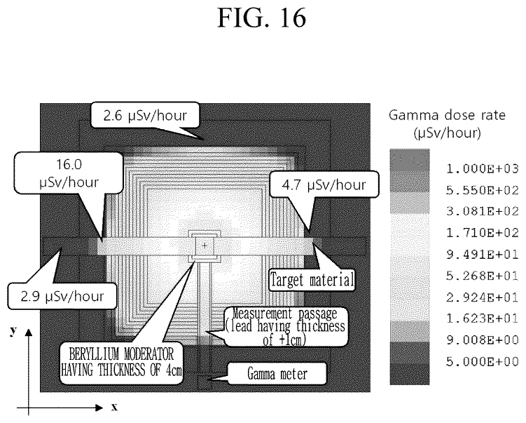

FIG. 15 is a view showing a gamma dose rate distribution in the absence of any target material in the PGNAA apparatus according to another exemplary embodiment of the present disclosure shown in FIG. 6, and FIG. 16 is a view showing a gamma dose rate distribution in the absence of any target material in the PGNAA apparatus according to another exemplary embodiment of the present disclosure shown in FIG. 8.

Referring to FIGS. 15 and 16, it can be confirmed that the gamma dose rate distributions have the same tendency as the neutron dose rate distributions shown in FIGS. 13 and 14. That is, it is confirmed that, when no target material O is inserted into the PGNAA apparatus, there is no big problem in the y-z direction shown in FIG. 15, but leakage occurs in the space where there is no target material O in the x-y direction shown in FIG. 16. However, it can be seen that the gamma dose rate drops to about 2.9 μSv/hour or lower in a space apart from the PGNAA apparatus by about 22 cm, and the gamma dose rate satisfies 4.7 μSv/hour, which is a reference value, at a distance of about 5 cm from the conveyor belt even near the surface of the PGNAA apparatus.

That is, as confirmed in FIGS. 13 to 16, in the PGNAA apparatus according to the present disclosure, it can be confirmed that, even in a situation where there is no target material O, the target dose rate is satisfied from the perspective of shielding neutrons and gamma rays in a space apart from the PGNAA apparatus by about 22 cm or at a distance of about 5 cm from the conveyor belt.

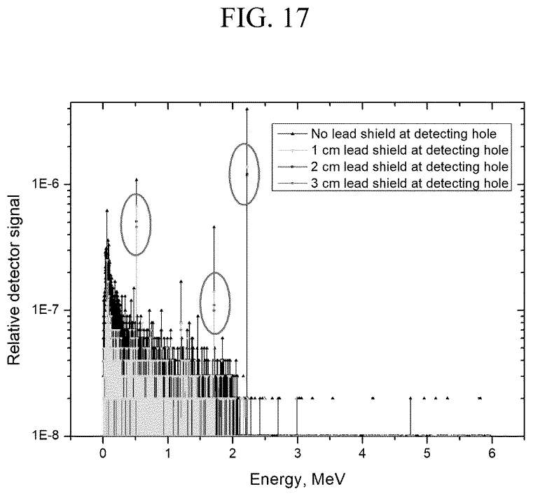

FIG. 17 is a graph showing a shielding effect, which is expressed as a measured gamma signal, when the gamma-ray shield is placed in the gamma-ray measurement passage in the PGNAA apparatus according to an exemplary embodiment of the present disclosure.

As shown in FIGS. 6 to 8, the gamma-ray shield 32 may be provided on the inner wall of the gamma-ray measurement passage 30, and the gamma-ray shield 32 may be made of lead.

Referring to FIG. 17, which shows gamma rays reacting with materials other than the target material O when no gamma-ray shield 32 is provided on the gamma-ray measurement passage 30, when a gamma-ray shield 32 having a thickness of 1 cm is provided on the gamma-ray measurement passage 30, when a gamma-ray shield 32 having a thickness of 2 cm is provided on the gamma-ray measurement passage 30, and when a gamma-ray shield 32 having a thickness of 3 cm is provided on the gamma-ray measurement passage 30, it can be confirmed that even if only 1 cm of lead is placed as a gamma-ray shield 32 on the gamma-ray measurement passage 30, it is possible to sufficiently shield gamma rays reacting with materials other than the target material O.

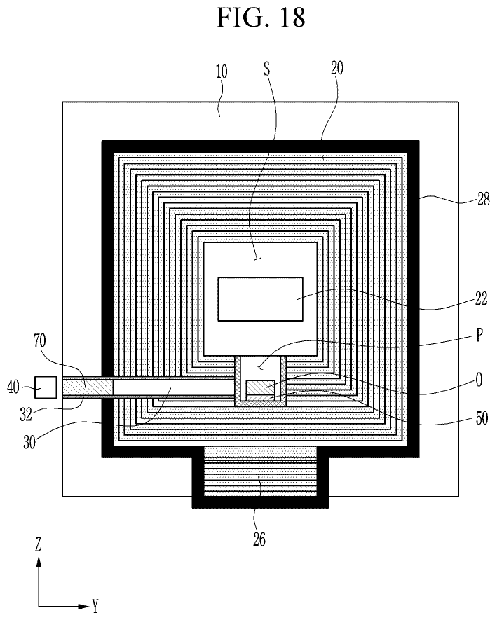

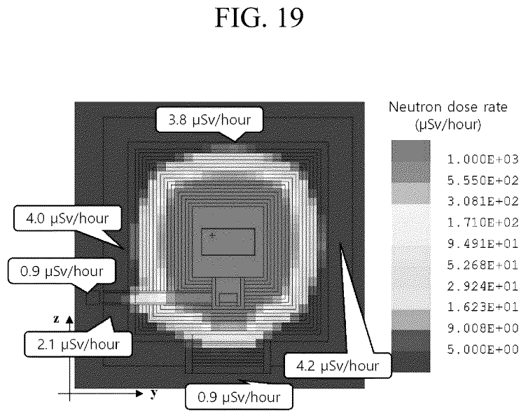

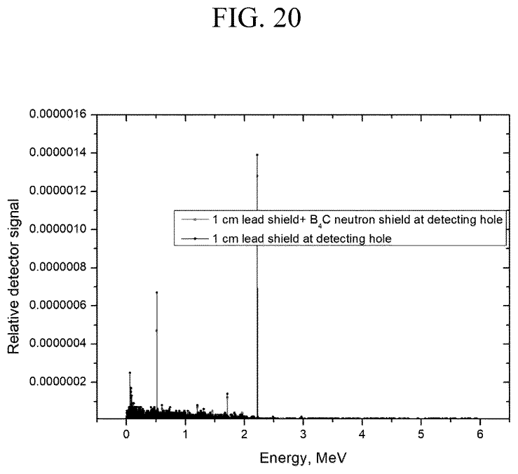

FIG. 18 is a view showing a state in which a dummy neutron absorber is further provided in the gamma-ray measurement passage of the PGNAA apparatus according to an exemplary embodiment of the present disclosure, FIG. 19 is a view showing a neutron dose rate distribution in the PGNAA apparatus according to an exemplary embodiment of the present disclosure shown in FIG. 18, and FIG. 20 is a graph showing a gamma signal measured in the PGNAA apparatus according to an exemplary embodiment of the present disclosure shown in FIG. 18.

As shown in FIG. 18, in the PGNAA apparatus according to an exemplary embodiment of the present disclosure, the gamma-ray measurement passage 30 may further be provided with a dummy boron carbide (B₄C) neutron absorber 70.

As shown in FIG. 20, when the dummy neutron absorber 70 is placed in the gamma-ray measurement passage 30, there are side effects such as reaction of the dummy neutron absorber 70 with leaked neutrons, resulting in generation of additional background noise and attenuation of prompt gamma rays generated from the target material O. However, as shown in FIG. 19, there is an effect of reducing the neutron dose rate from 2.9 μSv/hour, which is a conventional neutron dose rate, to 0.9 μSv/hour.

In this way, the PGNAA apparatus according to an exemplary embodiment of the present disclosure is capable of minimizing the leaked neutron dose even though a high-yield neutron source is used, by applying a neutron shield.

In addition, the PGNAA apparatus according to an exemplary embodiment of the present disclosure is capable of improving the gamma-ray measurement efficiency, by applying a beryllium moderator to maximize the rate at which the material to be measured reacts with neutrons.

In addition, the PGNAA apparatus according to an exemplary embodiment of the present disclosure is capable of improving the reliability of measurement results, by connecting a gamma-ray measurement passage to a space where there is a material to be analyzed, covering the gamma-ray measurement passage with a gamma-ray shield, and locating a gamma meter at an exit of the gamma-ray measurement passage to accurately measure only gamma rays that have reacted with the target material as much as possible.

In addition, the present disclosure, which proposes a concept for designing a neutron shield, can be easily applied to conventional PGNAA apparatuses.

Although the preferred exemplary embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

### DESCRIPTION OF SYMBOLS

100: PGNAA apparatus
O: target material
S: source space
P: target space
10: case
15: boron carbide (B₄C) neutron absorber
20: neutron shield
22: neutron source
24: (beryllium) moderator
26: dummy neutron shield
30: gamma-ray measurement passage
28, 32: gamma-ray shield
40: gamma meter
60: penetration portion
70: dummy boron carbide (B₄C) neutron absorber

What is claimed is:

1. A prompt gamma neutron activation analysis (PGNAA) apparatus for measuring prompt gamma rays emitted by irradiating a material to be analyzed with neutrons, the PGNAA apparatus comprising:
a case having a predetermined thickness;
a neutron shield disposed inside the case and having a predetermined thickness, with a source space in which a neutron source is disposed and a target space extending on one side of the source space for inserting the target material therein;
a gamma-ray measurement passage communicating with the outside by penetrating the neutron shield and the case from the target space; and
a gamma meter disposed outside adjacent to the gamma-ray measurement passage to measure prompt gamma rays emitted from the target material.

2. The PGNAA apparatus of claim 1, wherein
an inner wall of the target space is covered with a moderator made of one of metallic beryllium (Be), beryllium oxide (BeO), magnesium oxide (MgO), light water (H₂O), and heavy water (D₂O).

3. The PGNAA apparatus of claim 2, wherein
the moderator has a thickness of 3.5 cm to 4.5 cm.

4. The PGNAA apparatus of claim 1, wherein
an outer wall of the case is covered with a neutron absorber made of one of boron carbide (B₄C), borated steel, and cadmium (Cd).

5. The PGNAA apparatus of claim 1, wherein
the neutron shield is made one of polyethylene (HDPE), titanium hydride (TiH₂), zirconium borohydride (Zr(BH₄)₄), magnesium borohydride (Mg(BH₄)₂), and yttrium dihydride (YH₂).

6. The PGNAA apparatus of claim 1, wherein
the neutron shield has a thickness of 30 cm to 34 cm.

7. The PGNAA apparatus of claim 1, wherein
the target space is a space having a predetermined depth and formed in a rectangular shape while being smaller than the source space.

8. The PGNAA apparatus of claim 7, wherein
the target space has a depth of 15.5 cm to 16.5 cm.

9. The PGNAA apparatus of claim 7, wherein
the gamma-ray measurement passage extends in a direction perpendicular to an inner wall of the target space or extends at a certain angle in a vertical direction.

10. The PGNAA apparatus of claim 9, wherein
the gamma-ray measurement passage is formed to have a circular cross-section.

11. The PGNAA apparatus of claim 1, wherein
an inner wall of the gamma-ray measurement passage is covered with a gamma-ray shield.

12. The PGNAA apparatus of claim 11, wherein
the gamma-ray shield has a thickness of 1 cm or more.

13. The PGNAA apparatus of claim 11, wherein
the gamma-ray shield is made of lead (Pb).

14. The PGNAA apparatus of claim 1, further comprising:
a dummy neutron shield formed inside the case, the dummy neutron shield being formed integrally with the neutron shield and having a size larger than or equal to a size of the target space.

15. The PGNAA apparatus of claim 14, wherein
the dummy neutron shield is formed at a position spaced apart from the target space at a predetermined distance in a direction that is the same as a direction in which the neutron source faces the target space.

16. The PGNAA apparatus of claim 15, wherein
the neutron shield and the dummy neutron shield are surrounded by a gamma-ray shield.

17. The PGNAA apparatus of claim 16, wherein
the gamma-ray shield is made of lead (Pb).

18. The PGNAA apparatus of claim 1, wherein
the target space communicates with a penetration portion formed for a conveyor belt on which the target material is placed to penetrate the case and the neutron shield.

19. The PGNAA apparatus of claim 18, wherein
the penetration portion has a height that is equal to a height of the target space.

20. The PGNAA apparatus of claim 1, further comprising:
a dummy boron carbide (B₄C) neutron absorber formed in the gamma-ray measurement passage.
